(19) United States
(12) Patent Application Publication
(10) Pub. No.: US 2011/0114050 A1
(43) Pub. Date: May 19, 2011

(54) VARIABLE INTAKE DUCT STRUCTURE OF ENGINE

(75) Inventor: Woomin Jung, Hwaseong-si (KR)

(73) Assignees: Hyundai Motor Company, Seoul (KR); Kia Motors Corporation, Seoul (KR)

(21) Appl. No.: 12/841,455

(22) Filed: Jul. 22, 2010

(30) Foreign Application Priority Data
Nov. 19, 2009 (KR) 10-2009-0112231

(51) Int. Cl. F02M 35/10

(52) U.S. Cl. 123/184.56

(57) ABSTRACT

A variable air intake duct structure controls an air amount supplied to each combustion chamber according to engine speed that is subdivided into various steps. The variable intake duct structure is for an engine having an air duct for controlling an air amount supplied to an engine and may include first, second, and third ducts. The air ducts may be selectively opened or closed according to engine speed.

### CROSS-REFERENCE TO RELATED APPLICATION

This application claims priority to and the benefit of Korean Patent Application No. 10-2009-0112231 filed in the Korean Intellectual Property Office on Nov. 19, 2009, the entire contents of which are incorporated herein by reference.

### BACKGROUND OF THE INVENTION

1. Field of the Invention

The present relates to a variable air intake duct structure, and more particularly to a variable air intake duct structure that is capable of controlling an air amount supplied to each combustion chamber according to engine speed that is subdivided into various steps.

2. Description of the Related Art

Generally, in an intake system for a vehicle internal combustion engine (hereinafter simply referred to as “engine”) that is mounted on a vehicle such as an automobile, air drawn in through an air intake duct is filtered by an air cleaner element in an air cleaner box and is supplied to an intake port of the engine. Further, multiple ducts may be provided to compensate for the lack of inhaled or drawn-in air when the engine operates at a high-speed high-load region.

A conventional variable intake duct system is an intake system for a vehicle internal combustion engine in which a bifurcated air intake duct is connected to an air cleaner housing. When the engine operates at a low-speed low-load region, air is drawn in through only one of the openings of the intake duct. When the engine operates at a high-speed high-load region, air is drawn in through both the openings of the intake duct.

Herein, such air intake system is divided into a dual air intake system of a symmetrical type and a single air intake system.

Among them, the dual air intake system of a symmetrical type has a drawback that the manufacturing cost and weight is increased and a space for designing an engine compartment is limited.

Further, as to the single air intake system, high engine output performance or NVH performance is not reliable therewith.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a variable intake duct structure of an engine having advantages of precisely controlling an air amount supplied to each combustion chamber according to engine speed that is subdivided into various steps.

The variable intake duct structure of an engine having an air duct for controlling an air amount supplied to an engine may include first, second, and third ducts, wherein the air ducts may be selectively opened or closed according to engine speed.

The variable intake duct structure of an engine may further include first, second, and third open/close valves.

Predetermined engine speeds may include a first predetermined speed, a second predetermined speed, and a third predetermined speed, and the open/close valves are controlled according to the predetermined speeds.

The first predetermined speed may be in a range of 0 to 2400 RPM, and in case of the first predetermined speed, the second and third open/close valves are closed.

The second predetermined speed may be in a range of 2400 to 5500 RPM, and in case of the second predetermined speed, the third open/close valve is closed.

The third predetermined speed may be in a range of 5500 to 6400 RPM, and in case of the third predetermined speed, the first, second, and third open/close valves are opened.

Further, the variable intake duct structure of an engine may also include a first air cleaner disposed at a place where air passing through the first and second air ducts is joined together, and a second air cleaner disposed at a place where air passing through the third air duct passes.

There may be multiple air ducts and open/close valves.

### BRIEF DESCRIPTION OF THE DRAWINGS

FIG. 1 is a top plan view that shows air flow passing through an exemplary variable intake duct structure of an engine according to the present invention.

FIG. 2 is a top plan view of an exemplary variable intake duct structure of an engine applied to a vehicle according to the present invention.

FIG. 3 shows air flow in case of a low/middle load state of an exemplary variable intake duct structure of an engine according to the present invention.

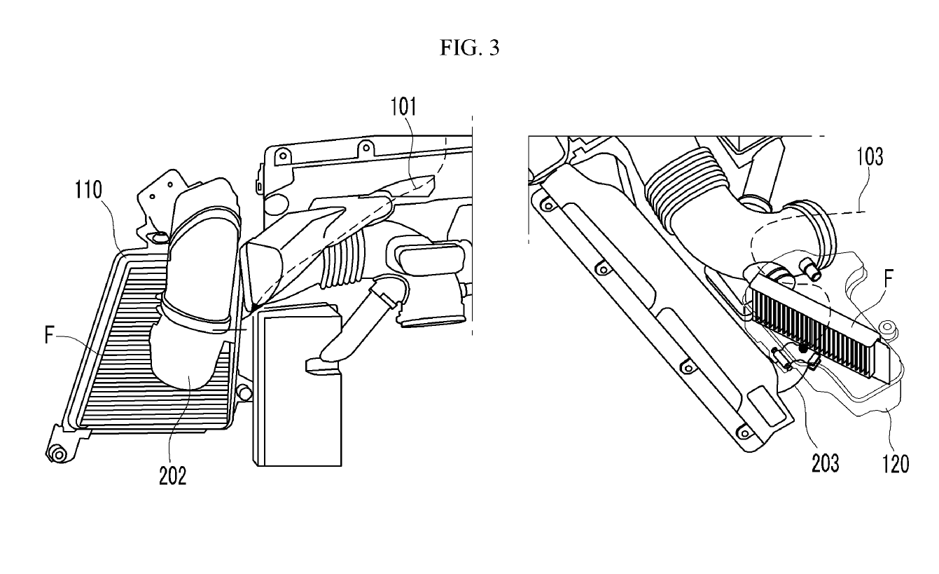

FIG. 4 is shows air flow in case of a middle/high state of an exemplary variable intake duct structure of an engine according the present invention.

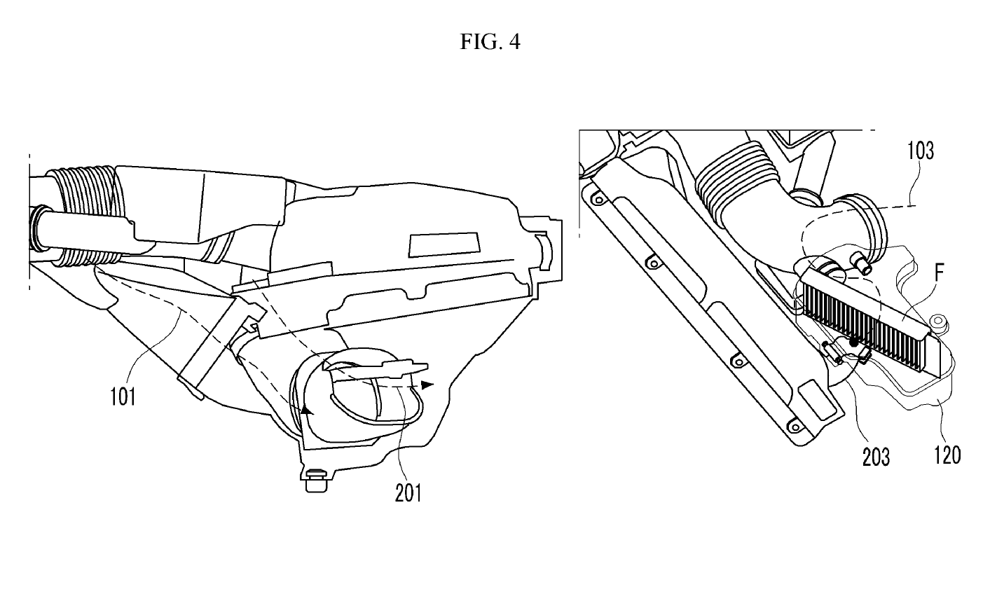

FIG. 5 shows air flow in case of the highest state of an exemplary variable intake duct structure of an engine according to the present invention.

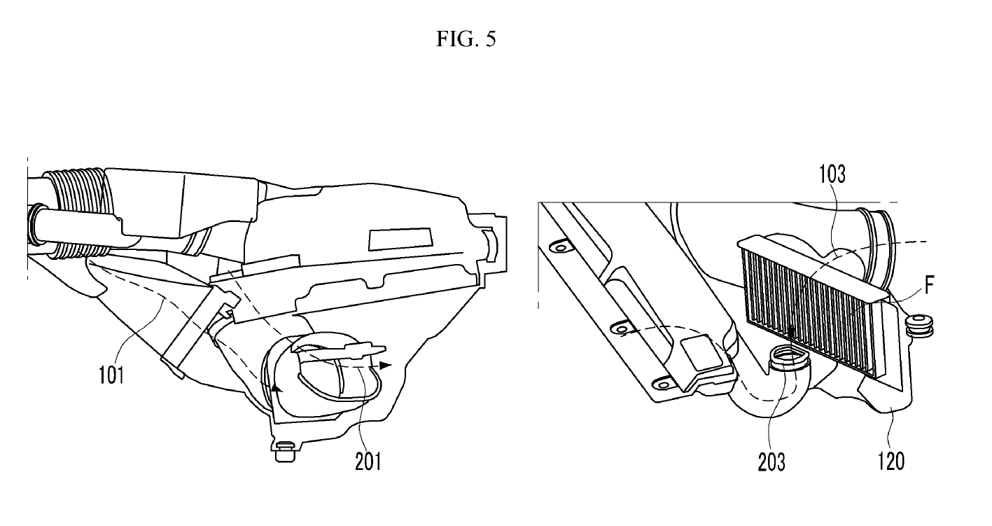

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

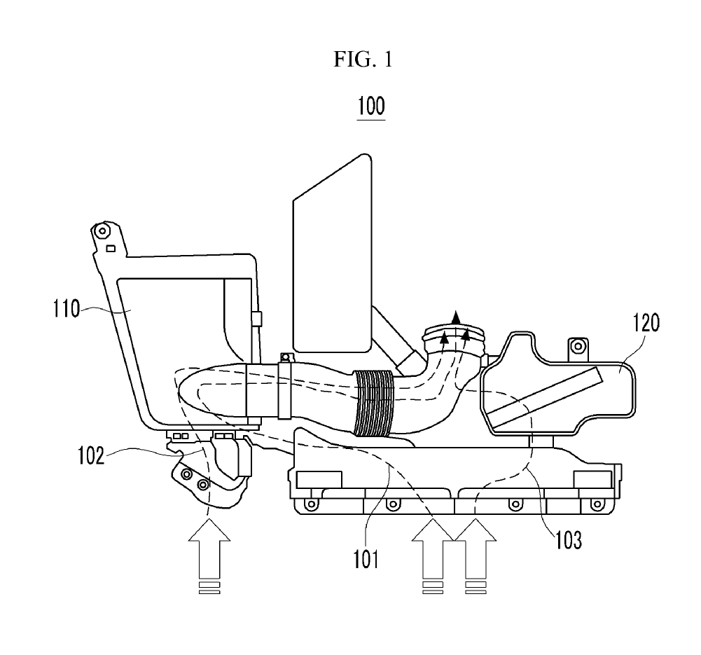

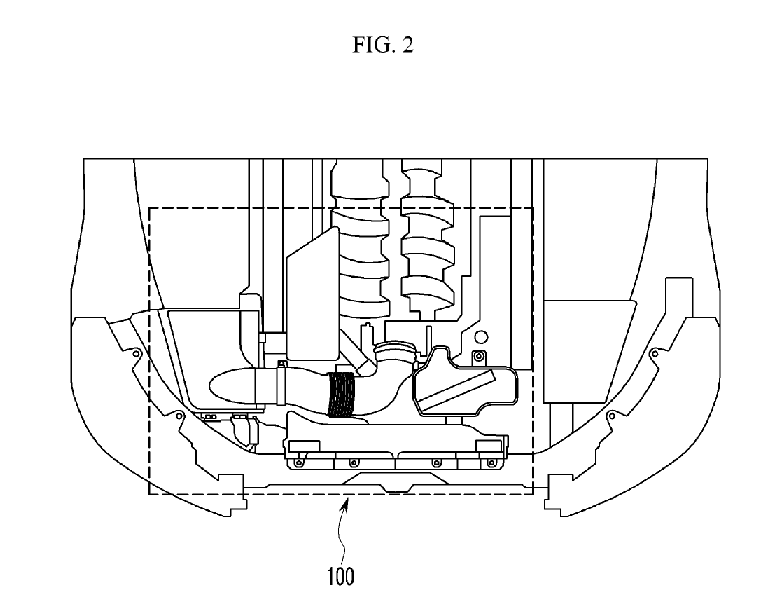

As shown in FIG. 1 and FIG. 2, a variable intake duct structure 100 of an engine according to various embodiments of the present invention includes a first air cleaner 110, and a second air cleaner 120 having a communicating hole communicated to an intake port of a first intake pipe and a second intake pipe.

The first air cleaner 110 and the second air cleaner 120 may be made of resin material manufactured by injection molding.

A filter element F is mounted inside the air cleaners.

The filter element F is a filter material of a conventional material for filtering intake air.

Hereinafter, dotted arrows shown in the drawings indicate each air duct and air flow passing through the air ducts.

Herein, a first air duct 101 and a second air duct 102 communicate with a frontal side of the first air cleaner 110 for inhaling air to the inside of the first air cleaner 110.

The first air duct 101 draws in low temperature air from the outside thereof from a front central portion of a vehicle.

A first open/close valve 201 is mounted at a connected portion between the first air duct 101 and the first air cleaner 110.

Further, a second air duct 102 and a third air duct 103 are respectively disposed at both sides of the first air duct 101.

As described above, the second air duct 102 is joined to the first air duct 101 and then communicated to the first air cleaner 110.

Herein, a second open/close valve 202 is mounted at a connected portion between the second air duct 102 and the first air cleaner 110.

The third air duct 103 is communicated to the second air cleaner 120 disposed at an opposite side of the first air cleaner 110.

Herein, the third open/close valve 203 is mounted at a connected portion between the third air duct 103 and the second air cleaner 120.

Four or more air ducts can be provided as long as the first/second/third air ducts 101, 102, and 103 are not limited in the space so as to control the air amount more precisely.

That is, the first/second/third air ducts 101, 102, and 103 are respectively partitioned and the first/second/third open/close valves are selectively opened or closed, thereby an engine is maintained safety according to a state of the engine, i.e., high/middle/low speeds, by precisely controlling an air amount.

Herein, because the target air amount is changed according to a state of high speed or low speed, the air amount can be decreased in case of low speed, and on the contrary that, the air amount must be increased so as to improve the performance of the engine.

For example, the first open/close valve 201 is opened in case of a first predetermined speed as low/middle speeds, particularly in case of 0 to 2400 RPM, and the second and third open/close valves 202 and 203 are closed such that the air flows through only one passage of the three. Thus, the least air amount is drawn in.

Further, the first and second open/close valves 201 and 202 are opened in case of a second predetermined speed as middle/high speeds, particularly in case of 2400 to 5500 RPM, and simultaneously the third open/close valve 203 is closed, such that the air drawn in through only two valves is supplied.

At this time, the third air duct 103 is blocked by the third open/close valve 203, so NVH effects—noise, vibration, and harshness—are improved.

In addition, the first/second/third open/close valves are opened in case of a third predetermined speed as the highest speed, particularly in case of 5500 to 6400 RPM, such that the air drawn in through all three valves is supplied. Thus, the maximum amount of the air is drawn in, so the engine is operated with maximum output power.

Further, exhaust gas, that is, evaporated HC gas or blow-by gas from an intake system in case of engine stop is reduced by being filtered by the air flow of the second air cleaner 120.

Herein, the second air cleaner 120 stably generates an oscillation as a resonator function, so an oscillation frequency is stabilized. Thus, a specific oscillation frequency can be reduced.

As can be seen from the variable intake duct structure of an engine according to various embodiments of the present invention, the second air duct 102 is opened in case of middle/highest speed.

Therefore, the air amount flowing into the engine is increased, so output power of the engine is increased.

In this way, the chamber air cleaner performs as an NVH reducing device.

In case of the highest speed of the engine, the maximum air amount is required for producing maximum output power of the engine.

At this time, all the air ducts are opened, so the maximum output power of the engine is realized.

For convenience in explanation and accurate definition in the appended claims, the terms “front” or “rear”, “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A variable intake duct structure of an engine comprising:
an air duct for controlling an air amount supplied to an engine; and
the air duct including first, second, and third ducts;
wherein the ducts are selectively opened or closed according to engine speed.

2. The variable intake duct structure of an engine of claim 1, further comprising first, second, and third open/close valves therein.

3. The variable intake duct structure of an engine of claim 1, wherein the engine speed includes a first predetermined speed, a second predetermined speed, and a third predetermined speed, and the open/close valves are controlled according to the predetermined speeds.

4. The variable intake duct structure of an engine of claim 3, wherein the first predetermined speed is in a range of 0 to 2400 RPM, and in case of the first predetermined speed, the second and third open/close valves are closed.

5. The variable intake duct structure of an engine of claim 3, wherein the second predetermined speed is in a range of 2400 to 5500 RPM, and in case of the second predetermined speed, the third open/close valve is closed.

6. The variable intake duct structure of an engine of claim 3, wherein the third predetermined speed is in a range of 5500 to 6400 RPM, and in case of the third predetermined speed, the first, second, and third open/close valves are opened.

7. The variable intake duct structure of an engine of claim 1, further comprising a first air cleaner disposed at a place where air passing through the first and second air ducts is joined together, and a second air cleaner disposed at a place where air passing through the third air duct passes.

8. The variable intake duct structure of an engine of claim 1, wherein there are multiple air ducts and open/close valves.

9. An engine the variable intake duct structure of claim 1.
